(19) United States
(12) Patent Application Publication
(10) Pub. No.: US 2021/0123652 A1
(43) Pub. Date: Apr. 29, 2021

(54) SENSOR ASSEMBLY FOR DETECTING THE LEVEL OF ICE WITHIN AN ICE MAKING APPLIANCE

(71) Applicant: Haier US Appliance Solutions, Inc., Wilmington, DE (US)

(72) Inventors: Richard Devos, Goshen, KY (US); Gregory Sergeevich Chernov, Louisville, KY (US); Andrew Reinhard Krause, Louisville, KY (US)

(21) Appl. No.: 16/665,405

(22) Filed: Oct. 28, 2019

(51) Int. Cl. F25C 5/20; G01S 17/88; G01S 7/481

(52) U.S. Cl. CPC F25C 5/22; G01S 17/88; F25C 2700/02; F25C 2600/04; G01S 7/4817

(57) ABSTRACT

A sensor assembly for controlling the operation of an ice making appliance is provided. The ice making appliance includes an ice maker that forms and dispenses ice into an ice bucket. A sensor assembly includes an emitter for generating a beam of energy and a receiver that monitors the time of flight of the beam of energy to determine a level of the ice within the ice bucket.

### FIELD OF THE INVENTION

The present subject matter relates generally to ice making appliances, and more particularly to sensor assemblies for detecting the level of ice to facilitate improved ice dispensing by ice makers in refrigerator appliances.

### BACKGROUND OF THE INVENTION

Refrigerator appliances generally include a cabinet that defines one or more chilled chambers for receipt of food articles for storage. Typically, one or more doors are rotatably hinged to the cabinet to permit selective access to food items stored in the chilled chamber. Further, refrigerator appliances commonly include ice making assemblies mounted within an icebox on one of the doors or in a freezer compartment. The ice is stored in a storage bin or ice bucket and is accessible from within the freezer chamber or may be discharged through a dispenser recess defined on a front of the refrigerator door.

Conventional ice making assemblies include features for determining when the ice bucket is full to prevent overfilling the ice bucket. For example, ice making assemblies commonly include mechanical arms that are displaced when ice fills the ice bucket, thereby triggering the ice maker to stop making ice. However, such mechanical systems are complex, have low reliability, poor accuracy, and frequent performance problems. Other level detections systems that rely on optical reflectance or acoustics are available, but are often costly, complex, experience sound or light interference, and require complex control hardware.

Accordingly, ice making appliance with features for improved ice dispensing would be desirable. More particularly, an ice making assembly for a refrigerator appliance that includes a sensor assembly for providing accurate ice level measurements would be particularly beneficial.

### BRIEF DESCRIPTION OF THE INVENTION

Aspects and advantages of the invention will be set forth in part in the following description, or may be apparent from the description, or may be learned through practice of the invention.

In a first exemplary embodiment, an ice making appliance is provided defining a vertical direction. The ice making appliance includes an ice bucket defining a storage chamber for receiving ice and a sensor assembly for detecting a level of the ice within the storage chamber. The sensor assembly includes an emitter for generating a beam of energy, a receiver for detecting the beam of energy reflected by the ice within the storage chamber, and a controller for determining the level of the ice within the storage chamber based at least in part on a travel time of the beam of energy between the emitter and the receiver.

According to another exemplary embodiment, a sensor assembly for regulating an ice making assembly to fill a container with ice is provided. The sensor assembly includes an emitter for generating a beam of energy, a receiver for detecting the beam of energy reflected by the ice within the container, and a controller for determining the level of the ice within the container based at least in part on a travel time of the beam of energy between the emitter and the receiver.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an exemplary embodiment of the present subject matter.

FIG. 2 provides a perspective view of the exemplary refrigerator appliance of FIG. 1, with the doors of the fresh food chamber shown in an open position.

FIG. 3 provides a side schematic view of a sensor assembly for detecting the level of ice in an ice bucket according to an exemplary embodiment of the present subject matter.

FIG. 4 provides a perspective schematic view of the exemplary sensor assembly of FIG. 3 according to an exemplary embodiment of the present subject matter.

FIG. 5 provides a close-up perspective view of the exemplary sensor assembly of FIG. 3 according to an exemplary embodiment of the present subject matter.

FIG. 6 provides a method for operating a sensor assembly for determining a level of ice within an ice bucket according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

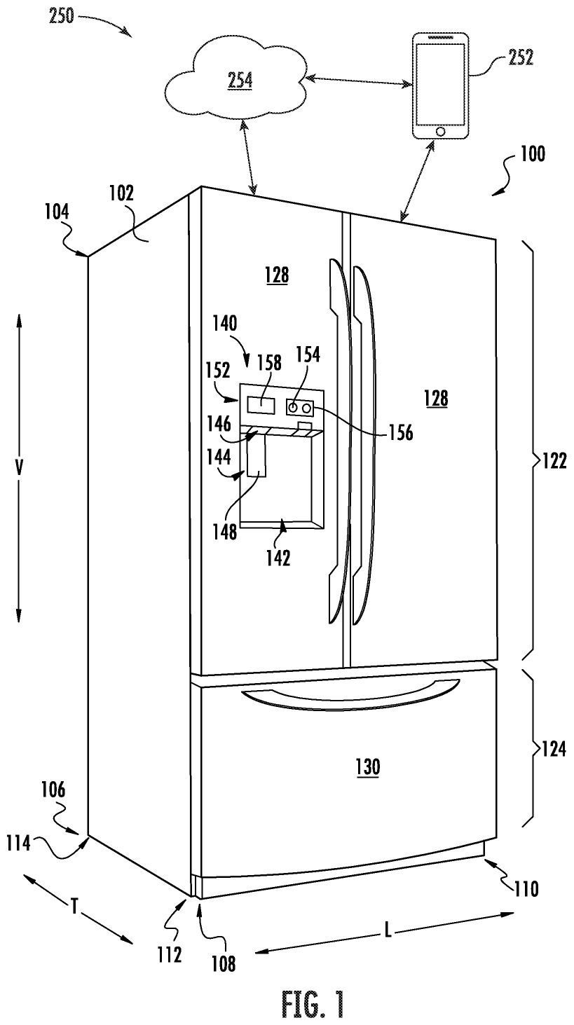

FIG. 1 provides a perspective view of a refrigerator appliance 100 according to an exemplary embodiment of the present subject matter. Refrigerator appliance 100 includes a cabinet or housing 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another.

Housing 102 defines chilled chambers for receipt of food items for storage. In particular, housing 102 defines fresh food chamber 122 positioned at or adjacent top 104 of housing 102 and a freezer chamber 124 arranged at or adjacent bottom 106 of housing 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applied to other appliances as well, such as other appliances including fluid dispensers. Consequently, the description set forth herein is for illustrative purposes only and is not intended to be limiting in any aspect to any particular appliance or configuration.

Refrigerator doors 128 are rotatably hinged to an edge of housing 102 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. Refrigerator doors 128 and freezer door 130 are shown in the closed configuration in FIG. 1. One skilled in the art will appreciate that other chamber and door configurations are possible and within the scope of the present invention.

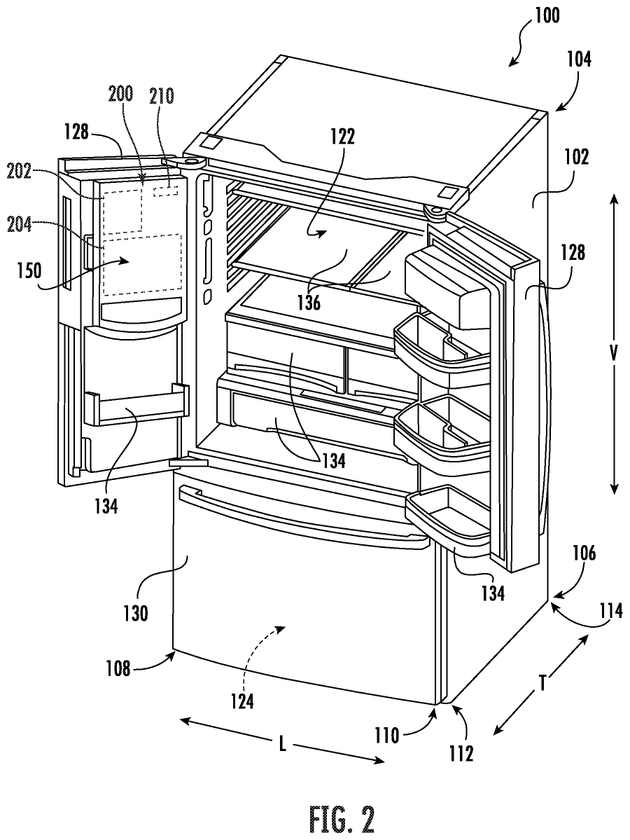

FIG. 2 provides a perspective view of refrigerator appliance 100 shown with refrigerator doors 128 in the open position. As shown in FIG. 2, various storage components are mounted within fresh food chamber 122 to facilitate storage of food items therein as will be understood by those skilled in the art. In particular, the storage components may include bins 134 and shelves 136. Each of these storage components are configured for receipt of food items (e.g., beverages and/or solid food items) and may assist with organizing such food items. As illustrated, bins 134 may be mounted on refrigerator doors 128 or may slide into a receiving space in fresh food chamber 122. It should be appreciated that the illustrated storage components are used only for the purpose of explanation and that other storage components may be used and may have different sizes, shapes, and configurations.

Referring again to FIG. 1, a dispensing assembly 140 will be described according to exemplary embodiments of the present subject matter. Although several different exemplary embodiments of dispensing assembly 140 will be illustrated and described, similar reference numerals may be used to refer to similar components and features. Dispensing assembly 140 is generally configured for dispensing liquid water and/or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 is defined on a front side 112 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

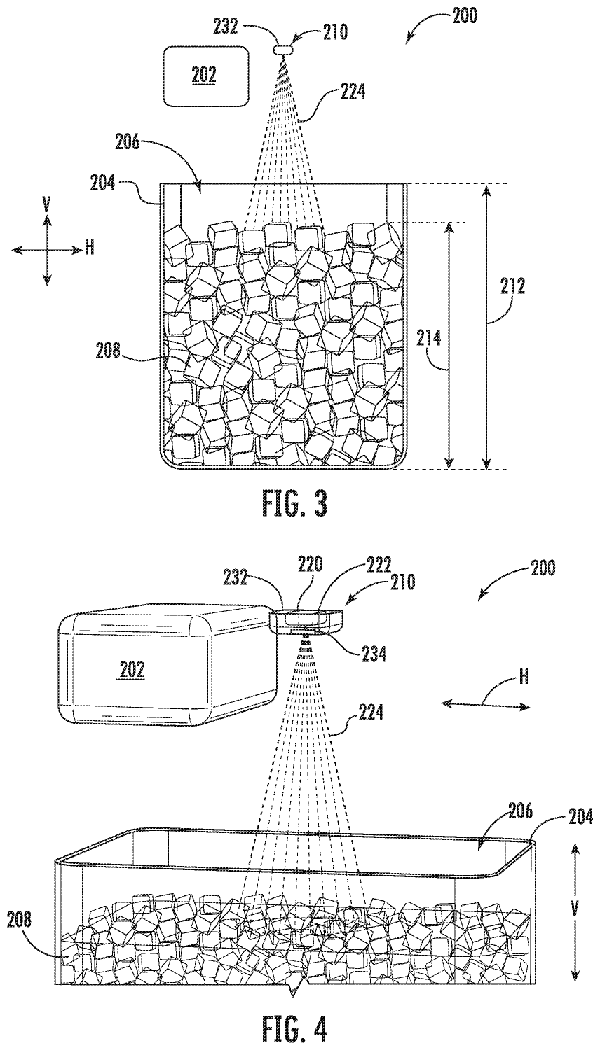

Dispensing assembly 140 includes an ice or water dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice or water dispenser 144. For example, ice or water dispenser 144 can include a sensor (such as an ultrasonic sensor) or a button rather than the paddle. Discharging outlet 146 and actuating mechanism 148 are an external part of ice or water dispenser 144 and are mounted in dispenser recess 142. By contrast, refrigerator door 128 may define an icebox compartment 150 (FIG. 2) housing an icemaker or ice making assembly and an ice storage bin (see FIGS. 3 through 5) that are configured to supply ice to dispenser recess 142.

A control panel 152 is provided for controlling the mode of operation. For example, control panel 152 includes one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with a processing device or controller 156. Signals generated in controller 156 operate refrigerator appliance 100 and dispensing assembly 140 in response to selector inputs 154. Additionally, a display 158, such as an indicator light or a screen, may be provided on control panel 152. Display 158 may be in communication with controller 156, and may display information in response to signals from controller 156.

As used herein, “processing device” or “controller” may refer to one or more microprocessors or semiconductor devices and is not restricted necessarily to a single element. The processing device can be programmed to operate refrigerator appliance 100, dispensing assembly 140 and other components of refrigerator appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

Referring now generally to FIGS. 3 and 4, in ice making appliance 200 will be described according to an exemplary embodiment of the present subject matter. According to the illustrated embodiment, ice making appliance 200 may be mounted within one of refrigerator doors 128, e.g., behind or above dispenser recess 142. Alternatively, ice making appliance 200 may be mounted within a freezer chamber 124 or at any other suitable location within refrigerator appliance 100. Although ice making appliance 200 is described herein as being used within refrigerator appliance 100, it should be appreciated that according to alternative embodiments, ice making assembly 200 may be a standalone ice making appliance, such as a countertop icemaker or industrial ice making machine.

In general, icemaker appliance 200 includes an ice making assembly or icemaker 202. Specifically, icemaker 202 may be any known ice making assembly, such as a crescent cube icemaker, a nugget icemaker, etc. Although icemaker 202 is illustrated schematically in FIGS. 3 and 4, it should be appreciated that any suitable type, style, and configuration of ice making assembly may be used according to alternative embodiments. In addition, ice making appliance 200 may have a dedicated controller, or may be operated by controller 156 of refrigerator appliance 100.

In general, ice making appliance 200 includes icemaker 202 and an ice storage container or ice bucket 204. In this regard, ice bucket 204 defines a storage chamber 206 for receiving and storing ice 208 that is formed by icemaker 202. As shown, ice making assembly 200 is generally positioned above ice bucket 204 and simply discharges ice directly or through a chute into ice bucket 204. However, it should be appreciated that according to alternative embodiments, icemaker 202 may be positioned at any other suitable location relative to ice bucket 204, such as below icemaker 202. According to such embodiments, an auger or another mechanism for moving ice 208 to ice bucket 204 may be used.

Notably, it is desirable that ice making assembly 200 generally keeps ice bucket 204 filled to a desired or target level with ice 208, e.g., to be ready for a user when desired. However, it is also important icemaker 202 knows when to stop producing ice, e.g., such that overfilling of ice bucket 204 may be avoided. As explained above, conventional ice level detection systems are clumsy mechanical or other costly and inefficient systems. Aspects of the present subject matter are directed to improved ice level detection systems for any suitable ice making appliance.

Specifically, referring generally to FIGS. 3 through 5, a sensor assembly 210 that may be used with ice making appliance 200 will be described according to an exemplary embodiment of the present subject matter. In general, sensor assembly 210 may be coupled with controller 156 for providing feedback regarding the amount of ice 208 within ice bucket 204, and generally facilitating controlled ice formation and storage of ice 208. Specifically, as described in more detail below, sensor assembly 210 may continuously or periodically measure the level or height of ice 208 within storage chamber 206. In addition, sensor assembly 210 may measure the ice level at a single location, along a single plane, at multiple locations, etc.

According to an exemplary embodiment, sensor assembly 210 may use a laser imaging, detection, and ranging (LiDAR) system to map the ice bucket 204 and ice 208 stored therein as described in more detail below. For example, as illustrated schematically in FIG. 3, sensor assembly may be used to measure a container height 212 and an ice level 214. In this manner, by continuously monitoring the ice making process, sensor assembly 210 may prevent overflows of ice bucket 204 by maintaining ice level 214 below container height 212. Although the simple example described herein relates to the measurement of ice level 214 generally, it should be appreciated that according to alternative embodiments, sensor assembly 210 may be able to monitor for a specific distribution of ice 208 within storage chamber 206. For example, sensor assembly 210 may detect a highest point of ice within ice bucket 204, sensor assembly 210 may detect if ice 208 is collecting along one side or at one location within storage chamber, etc.

According to alternative embodiments, sensor assembly 210 may be used to determine an empty volume of storage chamber 206, and to provide a command to operate icemaker 202 to fill ice bucket 204 as needed to fill the empty volume. In this regard, ice making appliance 200 may use sensor assembly 210 to provide feedback regarding the precise ice level 214 and may regulate the operation of icemaker 202 to maintain the ice level 214 at a target ice level, as described in more detail below. It should be appreciated that the fill levels and monitoring techniques may vary while remaining within scope of the present subject matter.

Referring still to FIGS. 3 through 5, sensor assembly 210 will be described in more detail according to exemplary embodiments. As shown, sensor assembly 210 is positioned adjacent icemaker 202 and includes an emitter 220 and a receiver 222. Specifically, as illustrated, emitter 220 and receiver 222 are installed above ice bucket 204 and are directed down toward ice 208 for properly determining ice level 214. According to exemplary embodiments, emitter 220 and receiver 222 are mounted on a single microchip or within a single device, though other configurations are possible. Alternatively, sensor assembly 210 may be mounted at any other suitable location within refrigerator appliance 100 or may be used in any other suitable refrigerator appliance or ice making appliance where accurate ice dispensing is desired. The exemplary embodiments described herein are not intended to limit the scope of the present subject matter in any manner.

In general, emitter 220 may be the source of any form of energy which may be measured or detected by receiver 222, e.g., for detecting the presence, location, geometry, and/or orientation of ice bucket 204, or more specifically, ice 208 stored therein. For example, according to the illustrated embodiment, emitter 220 and receiver 222 are an optical tracking system or laser tracking system. In this regard, for example, emitter 220 may include a laser diode or other suitable energy source for generating an energy beam 224. Similarly, receiver 222 may include an optical sensor or other suitable detector or sensor. In this manner, for example, emitter 220 and receiver 222 may generally define and operate as a LiDAR system, e.g., for detecting energy beam 224 after it has reflected off ice bucket 204, ice 208, etc. However, according to alternative embodiments, emitter 220 and receiver 222 may rely on principles of electromagnetism or other optical or sonar means for detecting positional and geometric data of ice bucket 204 and ice 208. Other devices for measuring this data are possible and within the scope of the present subject matter.

In general, energy beam 224 may be any suitable form of electromagnetic energy having any suitable wavelength. For example, according to an exemplary embodiment, energy beam 224 is electromagnetic energy having a wavelength of between about 500 and 1200 nm, or between about 700 and 1000 nm, or any other suitable wavelength. According to another exemplary embodiment, energy beam 224 is infrared light having a wavelength of approximately 940 nm. It should be appreciated that as used herein, terms of approximation, such as “approximately,” “substantially,” or “about,” refer to being within a ten percent margin of error.

According to one exemplary embodiment, emitter 220 is configured for generating and/or directing a single, linear energy beam 224 toward a single focal point, e.g., toward a center of ice bucket 204. As ice 208 fills storage chamber 206, the energy beam 224 directed from emitter 220 may strike ice 208, and controller 156 may determine the amount of time it takes for energy beam 204 to be emitted from emitter 220 and received by receiver 222 (e.g., a time of flight measurement). In this regard, for example, as ice 208 builds up in storage chamber 206, energy beam 224 will strike and return quicker than if storage chamber 206 were empty. In other words, after striking ice 208, the energy beam 224 may be reflected back to receiver 222 and may be monitored by a dedicated controller of sensor assembly 210, controller 156 of refrigerator appliance 100, or any other suitable device.

According to exemplary embodiments, based on the travel time it takes for energy beam 224 emitted from emitter 220 to be reflected back to receiver 222, sensor assembly 210 may determine a distance that the laser has travelled. From this distance and known angles related to the direction of energy beam 224 or other system constants, trigonometric relationships may be used to determine a height of the scanned point, e.g., the ice level 214. This scanning process may be performed periodically at a single point or may be performed at multiple locations continuously or at different times to achieve an accurate representation of the amount of ice 208 within storage chamber 206.

In this regard, for example, sensor assembly 210 may include a scanning assembly (not shown) that may move energy beam 224 along a particular scan path, e.g., including zigzag patterns or any other suitable pattern of movement for detecting ice 208 within storage chamber 206. Such a scanning assembly may include one or more rotatable or pivoting mirrors, servomotors, gyrometers, galvanometers, or any other suitable device or system of devices for moving the mirrors or otherwise redirecting energy beam 224 as desired. Alternatively, it should be appreciated that according to alternative embodiments, any other suitable positioning system may be used. Moreover, the entre scanning system can be miniaturized and executed as a micro electro mechanical system (MEMS) featuring microscopic mirrors and solid state, shape memory alloy, piezoelectric, or other suitable actuators. The exemplary scan paths and methods described herein are only exemplary and are not intended to limit the scope of the present subject matter in any manner.

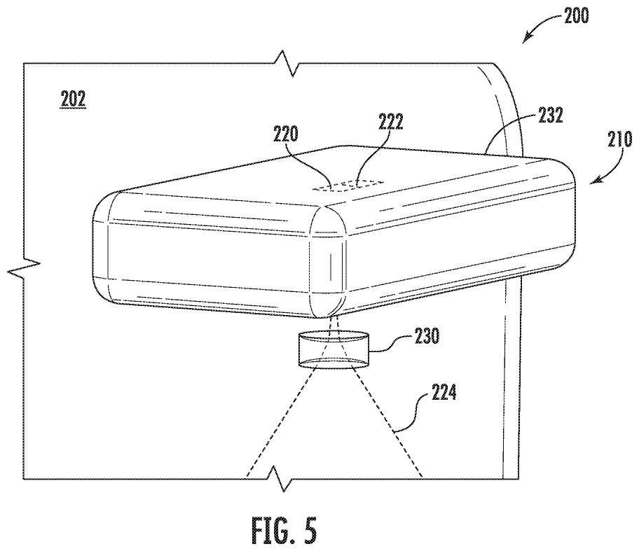

According to still other embodiments, sensor assembly 210 may include a lens assembly for modifying the field of view of energy beam 224. For example, as illustrated, the lens assembly may include a diverging lens 230 which is generally configured for diverging or dispersing energy beam 224. For example, as best shown in FIG. 5, diverging lens 230 may receive energy beam 224 at a single point and may spread energy beam 224 into a linear beam. The size and focus of diverging lens 230 may vary, e.g., to generate a linear energy beam 224 that extends across the entire width of ice bucket 204. According to still other embodiments, sensor assembly 210 may have an adjustable focus and may include a software program for selectively adjusting the field of view.

According to an exemplary embodiment, sensor assembly 210 may include a housing 232 within which emitter 220 and receiver 222 are positioned. According to exemplary embodiments, housing 232 may define a window 234 that is transparent to energy beam 224. According to exemplary embodiments, window 234 may be designed for focusing, defocusing, or redirecting energy beam 224. In addition, window 234 may be used independently of, or in conjunction with, diverging lens 230 to obtain the desired field of view of energy beam 224. As illustrated in FIG. 5, diverging lens 230 is positioned outside of housing 232. However, it should be appreciated that according to alternative embodiments, the diverging lens 230 may be positioned within housing 232.

According to the illustrated embodiment, sensor assembly 210 directs energy beam 224 substantially along the vertical direction V. However, it should be appreciated that according to alternative embodiments, energy beam 224 may be directed at any other suitable angle, such as an angle between the vertical direction V in a horizontal direction H. For example, according to the exemplary embodiment, an angle of the energy beam 224 relative to the vertical direction V may be between about 5° and 85°, between about 15° and 75°, between about 30° and 60°, or about 45°. Other suitable beam angles are possible and within the scope of the present subject matter.

It should be appreciated that controller 156 and/or sensor assembly 210 may include software programs and processors suitable for determining the level of ice 208 based on the transmission characteristics of the energy beam 224. For example, controller 156 may include control algorithms that facilitate the measurement of level of ice 208 within ice bucket 204. The algorithms typically include variety of input parameters, such as geometric constraints of the ice making appliance 200, measured variables or distances, and any other suitable constants or values. Trigonometric functions and relationships may be used to determine the actual height of a scanning point based at least in part on the travel time of the energy beam 224.

In addition, referring again to FIG. 1, refrigerator appliance 100 may generally include an external communication system 250 which is configured for enabling the user to interact with refrigerator appliance 100 using a remote device 252. Specifically, according to an exemplary embodiment, external communication system 250 is configured for enabling communication between a user, an appliance, and a remote server or network 254. According to exemplary embodiments, refrigerator appliance 100 may communicate with a remote device 252 either directly (e.g., through a local area network (LAN), Wi-Fi, Bluetooth, etc.) or indirectly (e.g., via a network 254), as well as with a remote server (not shown), e.g., to receive notifications, provide confirmations, input operational data, etc.

In general, remote device 252 may be any suitable device for providing and/or receiving communications or commands from a user. In this regard, remote device 252 may include, for example, a personal phone, a tablet, a laptop computer, or another mobile device. In addition, or alternatively, communication between the appliance and the user may be achieved directly through an appliance control panel (e.g., control panel 152).

In general, network 254 can be any type of communication network. For example, network 254 can include one or more of a wireless network, a wired network, a personal area network, a local area network, a wide area network, the internet, a cellular network, etc. In general, communication with network may use any of a variety of communication protocols (e.g., TCP/IP, HTTP, SMTP, FTP), encodings or formats (e.g. HTML, XML), and/or protection schemes (e.g., VPN, secure HTTP, SSL).

External communication system 250 is described herein according to an exemplary embodiment of the present subject matter. However, it should be appreciated that the exemplary functions and configurations of external communication system 250 provided herein are used only as examples to facilitate description of aspects of the present subject matter. System configurations may vary, other communication devices may be used to communicate directly or indirectly with one or more appliances, other communication protocols and steps may be implemented, etc. These variations and modifications are contemplated as within the scope of the present subject matter.

As one skilled in the art will appreciate, the above described embodiments are used only for the purpose of explanation. Modifications and variations may be applied, other configurations may be used, and the resulting configurations may remain within the scope of the invention. For example, sensor assembly 210 may be positioned at any suitable location, the type and operation of emitter 220 and receiver 222 may vary, and sensor assembly 210 may operate in any other suitable manner. One skilled in the art will appreciate that such modifications and variations may remain within the scope of the present subject matter.

Now that the construction and configuration of refrigerator appliance 100, ice making assembly 200, and sensor assembly 210 have been presented according to an exemplary embodiment of the present subject matter, an exemplary method 300 for operating an ice maker appliance is provided. Method 300 can be used to operate ice making assembly 200 and sensor assembly 210, or to operate any other suitable sensor or ice making assembly. In this regard, for example, controller 156 may be configured for implementing method 300. However, it should be appreciated that the exemplary method 300 is discussed herein only to describe exemplary aspects of the present subject matter, and is not intended to be limiting.

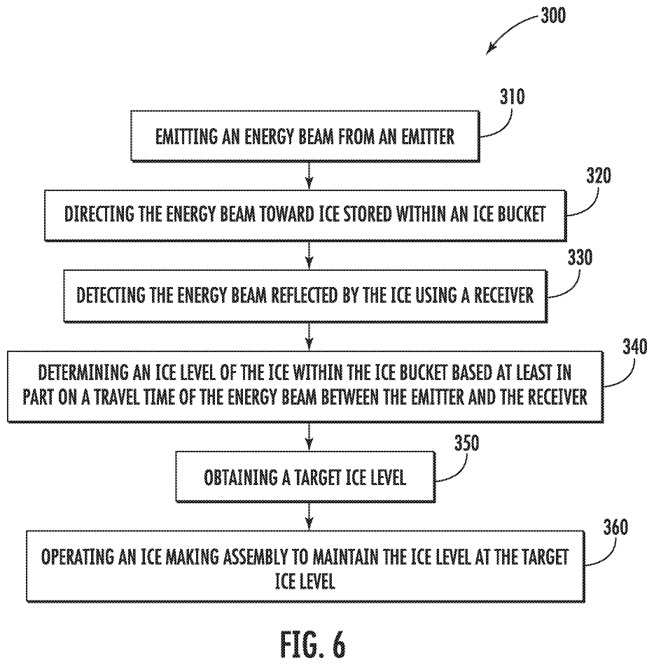

As shown in FIG. 6, method 300 includes, at step 310, emitting an energy beam from an emitter. Specifically, for example, emitter 220 may be mounted within housing 232 and may direct energy beam 224 through window 234 and/or a diverging lens 230. Step 320 includes directing the energy beam, e.g., using a scanning assembly toward ice 208. Step 330 includes detecting the energy beam reflected by the container or the ice at one or more scan positions using a receiver, such as receiver 222. In this regard, scanning assembly 230 directs energy beam 224 along a desired scan path to generate an accurate representation of ice bucket 204 and ice 208 located therein.

At step 340, a controller, such as controller 156, may determine an ice level of ice 208 within ice bucket 204. For example, the controller may determine the ice level based on the distance traveled by energy beam 224, which may be determined, for example, based at least in part on the travel time of energy beam 224 between the emitter and the receiver. Specifically, controller 156 may precisely determine the amount of time it takes for energy beam 224 emitted from the emitter 220 to travel to receiver 222. Based on the travel time, controller 156 may know the distance traveled by energy beam to ice 208. According to an exemplary embodiment, using this distance and/or trigonometric relationships (e.g., depending on the angle of energy beam 224), controller 156 may precisely determine the ice level 214.

According to exemplary embodiments of the present subject matter, sensor assembly 210 may be used to monitor the ice level 214 within storage chamber 206 and may stop an ice dispensing process when ice bucket 204 is full or at another suitable desired level. In this regard, step 350 may include obtaining a target ice level, e.g., as programmed by the manufacturer or set by remote device 252. Step 360 may include operating an ice making assembly to maintain the ice level at the target ice level.

FIG. 6 depicts an exemplary control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of the method are explained using sensor assembly 210 as an example, it should be appreciated that this method may be applied to the operation of any suitable appliance and/or ice making assembly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An ice making appliance defining a vertical direction, the ice making appliance comprising:
an ice bucket defining a storage chamber for receiving ice;
a sensor assembly for detecting a level of the ice within the storage chamber, the sensor assembly comprising:
an emitter for generating a beam of energy;
a receiver for detecting the beam of energy reflected by the ice within the storage chamber; and
a controller for determining the level of the ice within the storage chamber based at least in part on a travel time of the beam of energy between the emitter and the receiver.

2. The ice making appliance of claim 1, wherein the ice making appliance is positioned within a refrigerator appliance, the refrigerator appliance comprising:
a cabinet defining a chilled chamber;
a door being rotatably hinged to the cabinet to provide selective access to the chilled chamber, the door defining a dispenser recess; and
an ice making assembly for selectively forming and discharging the ice into the storage chamber.

3. The ice making appliance of claim 2, wherein the controller is further configured for:
obtaining a target level of the ice within the storage chamber; and
adjusting the operation of the ice making assembly to maintain the level of the ice at the target level.

4. The ice making appliance of claim 1, wherein the emitter and the receiver are positioned within a housing having a window that is transparent to the beam of energy emitted from the emitter.

5. The ice making appliance of claim 1, wherein the sensor assembly includes a diverging lens for dispersing the beam of energy.

6. The ice making appliance of claim 5, wherein the diverging lens generates a linear beam.

7. The ice making appliance of claim 5, wherein the diverging lens is positioned within a housing of the sensor assembly.

8. The ice making appliance of claim 5, wherein the sensor assembly comprises a software program for generating the beam of energy with a modified field of view.

9. The ice making appliance of claim 1, wherein the sensor assembly is positioned above the ice bucket along the vertical direction.

10. The ice making appliance of claim 1, wherein the beam of energy is directed at an angle between the vertical direction and a horizontal direction.

11. The ice making appliance of claim 10, wherein the angle is between about 10 and 70 degrees relative to the vertical direction.

12. The ice making appliance of claim 1, wherein the beam of energy is electromagnetic energy having a wavelength of between about 700 and 1000 nanometers.

13. The ice making appliance of claim 1, wherein the beam of energy is infrared light having a wavelength of approximately 940 nanometers.

14. The ice making appliance of claim 1, wherein the emitter and the receiver are part of laser imaging, detection, and ranging (LiDAR) system.

15. The ice making appliance of claim 1, wherein the emitter is a laser and the receiver is an optical receiver.

16. The ice making appliance of claim 1, wherein the emitter and the receiver are mounted on a single microchip.

17. The ice making appliance of claim 1, wherein the sensor assembly makes periodic measurements.

18. The ice making appliance of claim 1, wherein the sensor assembly determines the level of the ice at a plurality of scan positions.

19. The ice making appliance of claim 1, wherein the sensor assembly is in operative communication with a remote device.

20. A sensor assembly for regulating an ice making assembly to fill a container with ice, the sensor assembly comprising:
an emitter for generating a beam of energy;
a receiver for detecting the beam of energy reflected by the ice within the container; and
a controller for determining the level of the ice within the container based at least in part on a travel time of the beam of energy between the emitter and the receiver.
